(19) United States
(12) Patent Application Publication
(10) Pub. No.: US 2010/0233319 A1
(43) Pub. Date: Sep. 16, 2010

(54) METHOD OF TREATMENT OF ALCOHOLIC FERMENTATION RESIDUE WITH KOJI MOLD

(75) Inventor: Masahiro Yamamoto, Kagoshima (JP)

Correspondence Address: PEARNE & GORDON LLP, 1801 EAST 9TH STREET, SUITE 1200, CLEVELAND, OH, 44114-3108, US

(73) Assignees: Masahiro Yamamoto, Kagoshima (JP); Noriko Yamamoto, Kagoshima (JP)

(21) Appl. No.: 12/161,664

(22) PCT Filed: Jan. 24, 2006
(86) PCT No.: PCT/JP2006/301065

§ 371 Date: Oct. 28, 2008

(51) Int. Cl. A23K 1/06

(52) U.S. Cl. 426/52; 426/635

(57) ABSTRACT

Disclosed in a method for treating an alcoholic fermentation residue without the need of external supply of an energy source, which is characterized by mixing a koji mold (e.g., Asp. niger) having a cellulase activity with an alcoholic fermentation/unrefined distillation residue (SDBP) previously and then spraying the SDBP to a koji mold bed. This method is developed based on the fact that an SDBP contains fibrous materials in a large quantity. A first koji mold having a cellulase activity is mixed with an alcoholic fermentation residue, and the resulting mixture is added to a koji mold bed containing a second koji mold having an amylase activity to perform the fermentation process. A part of the resulting mold bed is taken out as necessary and is provided as a feeding stuff.

### TECHNICAL FIELD

The present invention relates to a method of treating an alcoholic fermentation residue by a koji mold. The present invention further relates to a feed composition obtained by said method.

### BACKGROUND ART

While alcoholic fermentation product (moromi) distillation residues (hereinafter referred to as “SDBP”) contain large amounts of water, having a water content of 95%, they also have an extremely high BOD of at least 10,000 ppm. They are therefore expensive to treat, and have become somewhat of a social issue. As methods of disposing of SDBP to solve this issue, we have developed technologies wherein SDBP is sprayed and mixed into a koji mold bed formed by growing koji mold on a raw material containing a starchy substance and a fibrous substance such as wheat bran or corn cobs, and causing the moisture in the SDBP to evaporate by the heat of fermentation thereof to product a high-quality, dry fermented feed composition, and have filed a patent application therefor (Japanese Patent Application No. S62-173923; published as JP S64-20090 A). This treatment method is characterized in that it requires absolutely no external heat, and is capable of drying to a water content of 20% or less using only the air that is blown for the purpose of adjusting the heat generated by the koji. The method has been noted and used as a treatment method that is of much lower cost than conventional methods.

However, the nutritive value of SDBP is a mere 160 kcal/kg (in the case of shochu effluents; according to the Standard Table of Feed Compositions in Japan) and therefore cannot be dried by fermentation heat alone, thus requiring the addition of another energy source such as waste oils or the like.

This energy calculation shall be explained below.

1 ton of SDBP contains 160×1000=160,000 kcal. On the other hand, since SDBP is 95% water, 1 ton of SDBP contains 950 liters of water. The latent heat of evaporation of this water is about 600 kcal/liter, so at least 600×950=570,000 kcal are needed to evaporate this water. Since this largely exceeds the 160,000 kcal contained in SDBP, it becomes necessary to supplement 570,000−160,000=410,000 kcal of energy.

While this energy was previously supplemented using waste oils from food, the cost of such food-based waste oils has recently risen, so the development of treatment technologies that do not require supplementation of external energy sources has become a priority for achieving lower costs.

### Patent Document 1: JP S64-20090 A

### DISCLOSURE OF THE INVENTION

### Problems to be Solved by the Invention

The technology we have now developed was achieved by focusing on the fact that SDBP contains large quantities of fibrous material. By spraying SDBP onto a koji mold bed after administering a koji mold (Asp. niger or the like) which has cellulase activity to the SDBP, we succeeded in eliminating the need to supplement external energy sources.

Cellulase hydrolyzes cellulose into glucose, cellubiose and oligosaccharides. Therefore, the fermentation of such substances obtained by cellulase activity has been conventionally performed using yeasts and lactic acid bacteria capable of breaking down these sugars.

However, until now, the use of raw materials pretreated with microbes having cellulase activity, particularly koji molds having cellulase activity, has not been attempted in fermentation treatments, which mainly use koji molds that are known to break down starches. On the other hand, in the evaluation of nutritive value described above, the energy that can be obtained by the decomposition of cellulose by cellulases is not taken into consideration.

### Means for Solving the Problems

The present invention relates to a method of efficiently fermenting an alcoholic fermentation residue such as moromi distillation residues, by using a cellulase-active koji mold as a pretreatment.

Therefore, the present invention offers a method of treating alcoholic residues by mixing a first koji mold having cellulase activity with an alcoholic fermentation residue, adding the mixture to a koji mold bed containing a second koji mold having amylase activity, and subjecting to a fermentation process. Surprisingly, with the method of the present invention, even without energy sources for koji mold fermentation such as starches and oils, it is possible to achieve the same level or better of fermentation as when these are used.

Alcoholic fermentation residues are residues obtained by extracting alcohol from moromi when producing alcohol for use in fuel or alcoholic beverages. The extraction of alcohol may be performed by distillation, filtration or the like. Alcoholic fermentation residues are rich in fibrous material.

The koji mold having cellulase activity used in the present invention is particularly Asp. niger, preferably a type of Asp. niger that is used for feed compositions.

In the method of the present invention, spores of a koji mold having cellulase activity are preferably added to a residue at a temperature of 40° C. or less at a concentration of at least 10 million per kg weight of residue. Furthermore, in addition to the koji mold having cellulase activity, it is possible to add a koji mold with a high heat generating ability due to fermentation by Asp. oryzae, Asp. awamori, Asp sojae and the like. After addition, the mixture is preferably aerated. In this way, the raw material is pretreated.

In the present invention, the alcoholic fermentation residue may have a water content of at least 60%, particularly of at least 90% by mass. The koji mold having cellulase activity which can be used in the present invention may, for example, be Asp. niger. This koji mold having cellulase activity is preferably added to the alcoholic fermentation residue in the form of spores. In this case, the method of the present invention can be suitably performed by adding the spores of the koji mold at a ratio of at least 10 million per kg of the alcoholic fermentation residue.

After a first koji mold having cellulase activity has been mixed into the alcoholic fermentation residue, the mixture is preferably added to a koji mold bed containing a second koji mold within 48 hours, preferably within 4 hours, and more preferably, added to a koji mold bed containing a second koji mold within 1 hour. The operation of mixing the first koji mold having cellulase activity with the alcoholic fermentation residue and the operation of adding the mixture to the koji mold bed containing the second koji mold may be performed simultaneously, in which case the first koji mold, the alcoholic fermentation residue and the koji mold bed containing the second koji mold may be mixed in any order.

The koji mold bed is formed by growing a koji mold on a substrate. Preferably, the substrate is a fibrous substrate such as wheat bran or corn cobs. Since corn cobs have good air permeation efficiency when blowing air during fermentation, the amount which is necessary with respect to the total amount of treated waste may be small, making it economical. The koji mold bed is preferably a koji formed by forming a koji mold on a fibrous substrate containing a starchy substance. The water content of the koji mold bed before addition of the alcoholic fermentation residue is preferably 20-35 wt %.

If there is some time after mixing the first koji mold with the alcoholic fermentation residue and before adding the mixture to a koji mold bed containing a second koji mold having amylase activity, the mixture is preferably aerated during that time. The second koji mold is preferably one of Asp. oryzae, Asp. awamori and Asp. sojae, or a mixture thereof. More preferably, the second koji mold is one or both of Asp. oryzae kawachii and Asp. awamori kawachii (available from Kawauchi Genichiro Shoten). The second koji mold may also have lipase activity.

The weight ratio of the mixture with respect to the koji mold bed should preferably be adjusted to put the water content of the koji mold bed after addition of the mixture in the range of 25-50 wt %, preferably 30-40 wt %. Furthermore, air should be blown into the koji mold bed to which the mixture has been added, in order to keep the koji mold bed at a temperature within the range of 25° C. to 50° C. As a result, the koji mold bed with the mixture added should be dried to a water content of 15-35%, preferably 15-30%. Since the koji mold can be grown with a low water activity of 0.9 or less, the koji mold can be exclusively grown and the growth of other microbes suppressed by holding the water activity to 0.87 or less.

Additionally, it is possible to repeatedly perform the method using a portion of the koji mold-fermented product obtained by the above method as a koji mold bed containing the second koji mold, enabling the alcoholic fermentation residue to be treated without addition of other koji molds, in particular, Asp. oryzae, Asp. awamori and Asp. sojae. However, since koji molds having cellulase activity usually have low heat generating ability, the heat of fermentation can become weak if only such koji molds are added. Therefore, the present invention can be more effectively performed by adding koji mold with high heat generating ability to alcoholic fermentation residues in addition to koji molds having cellulase activity. Koji molds having a high heat generating ability include, for example, Asp. oryzae, Asp. awamori and Asp. sojae, and are preferably Asp. oryzae kawachii and Asp. awamori kawachii. It is also possible to continuously treat alcoholic fermentation residues by withdrawing a portion of the koji mold-fermented product, adding the same amount of raw material substrate for the koji mold bed as the amount that was withdrawn, and repeating the above operations.

The product obtained by treating alcoholic fermentation residues according to the above method can be favorably used as a feed composition. Additionally, the present invention relates to a feed composition obtained by the above method.

### BEST MODES FOR CARRYING OUT THE INVENTION

Herebelow, a preferred embodiment of the present invention shall be described.

First, a koji mold bed formed by growing a koji mold on a substrate is prepared.

The koji mold may be of the type that is usually used for producing koji, specific examples including Aspergillus, preferably Asp. oryzae, Asp. awamori and Asp. sojae, more preferably Asp. oryzae kawachii and Asp. awamori kawachii (available from Kawauchi Genichiro Shoten), which may be used in combination with other molds and the like within such a range as not to interfere with the effects of the present invention.

The substrate for the koji mold bed is a fibrous material or a mixture of a fibrous material and a cereal, such as corn cobs, wheat bran, barley bran, rice bran, hay, beet pulp, rice, barley, rolled barley, wheat, oats, rye, soybeans, maize and food wastes. While a koji mold bed can be obtained by mixing a koji mold into a substrate set to an appropriate temperature and moisture, then allowing to ferment, it can also be obtained by the methods disclosed, for example, in JP 2002-142688 A, and JP 2002-336822 A and JP 2003-235465 A which make use of oils and fats. These methods result in koji mold beds without contamination in which koji mold is dominant.

Next, an alcoholic fermentation residue is treated with a first koji mold.

After adjusting the alcoholic fermentation residue to a temperature of 50° C. or less, more preferably 40° C. or less, spores of Asp. niger are added and suspended. Preferably, at least 10 million spores are added per kilogram of the alcoholic fermentation residue.

When letting stand after suspension, air is blown into the suspension at a rate of 100 liters/minute per ton of the suspension.

Next, the alcoholic fermentation residue treated by the first koji mold is sprayed over the prepared koji mold bed. After spraying, the water content of the koji mold bed was 50% or less, preferably 40% or less, and more preferably 25-40%. While the water content can be adjusted by controlling the amount of alcoholic fermentation residue used, it can also be adjusted, for example, by adding other raw materials that are relatively dry or wet, or by adding water or the like. The koji mold can be efficiently grown by adjusting the water content to achieve an environment that is favorable for molds.

The raw materials used in the present invention can also be treated such as by sterilization. While various methods of sterilization might be contemplated, the sterilization is preferably performed by heat sterilization, particularly steam sterilization or sterilization by hot oils. Steam sterilization is performed, for example, at about 100° C. for 30 minutes.

The mixture between the pretreated alcoholic fermentation residue and the koji mold bed is preferably kept in an isothermic tank, advantageously at 35-50° C. It can be effectively cooled by blowing air.

When the koji mold begins to ferment, some of the moisture evaporates due to the heat of fermentation. As a result, it is possible to obtain a feed composition having a desirable water content. The final target water content of the feed composition is 30 wt % or less, preferably 20 wt % or less, more preferably 15 wt % or less. If the water content of the feed composition exceeds 30 wt %, the total mass becomes very large, causing problems for storage and shipping. Additionally, it becomes more susceptible to putrefaction, and thus less suitable for long-term storage.

Additionally, when there is a need to further reduce the water content of the resulting feed composition, it can be dried by blowing hot air from a heater.

Furthermore, if the water content becomes low, preferably when it reaches a water content of about 20%, the treated alcoholic fermentation residue mentioned above can be further added and stirred, and the water content adjusted to about 30% to continue fermentation, and this can be repeated a number of times. In other words, the material obtained after the water content is reduced by fermentation can be reused as a koji mold bed.

### Example 1

1. A koji having wheat bran and corn cobs as the substrate is produced by conventional methods, and the water content is adjusted to 25% to 35%.
2. After adjusting the temperature of the SDBP to 40° C. or less, spores of Asp. niger are added and suspended at a concentration of at least 10 million per kg weight of SDBP. During the time elapsed after suspension until mixture with a koji mold bed containing a second koji mold, air is blown into the SDBP at a rate of at least 100 liters/minute per ton.
3. After suspension, this SDBP containing spores of Asp. niger is sprayed onto a koji mold bed adjusted in accordance with step 1, to adjust the water content to be within the range of 30% to 50%.
4. The koji mold bed to which the SDBP is added will begin to generate heat, so it is air-blown in order to maintain the temperature within the range of 25° C. to 50° C.
5. As a result, after 24 hours, the water content of the koji mold bed is dried to within the range of 20% to 35% from the original.
6. Portions of this mold bed are extracted as needed for use as feed compositions.
7. At the time of extraction, a substrate such as wheat bran or corn cob is added to the mold bed in the same amount as the amount extracted.

By repeating steps 2 and below, the SDBP is dried only by the heat of fermentation, without the need to separately add any new energy sources.

The fermentation efficiency was observed after performing the above steps.

The control was a koji mold bed mixed with an untreated SDBP.

Apart from the above, spores of Asp. niger were added to the SDBP at a concentration of 200 million per liter of SDBP, then aerated, and after passage of a predetermined period of time, mixed into the koji mold bed.

This was loaded into wooden boxes in 1 kg portions, then let stand in a room at a room temperature of 32 degrees. The graph of FIG. 1 shows the results of measurements of the increase in product temperature with each hour.

As is clear from these results, SDBP with Asp. niger added had a higher heat generating ability than the control.

Furthermore, the heat generating ability was highest 0 to 1 hour after addition. This can be inferred to be the result of Asp. niger consuming the nutrients in the SDBP with the passage of time.

From the above results, it is clear that the heat generating ability of SDBP can be increased by adding Asp. niger and mixing into a koji mold bed.

### BRIEF DESCRIPTION OF THE DRAWINGS

FIG. 1 is a graph showing the results of Example 1.

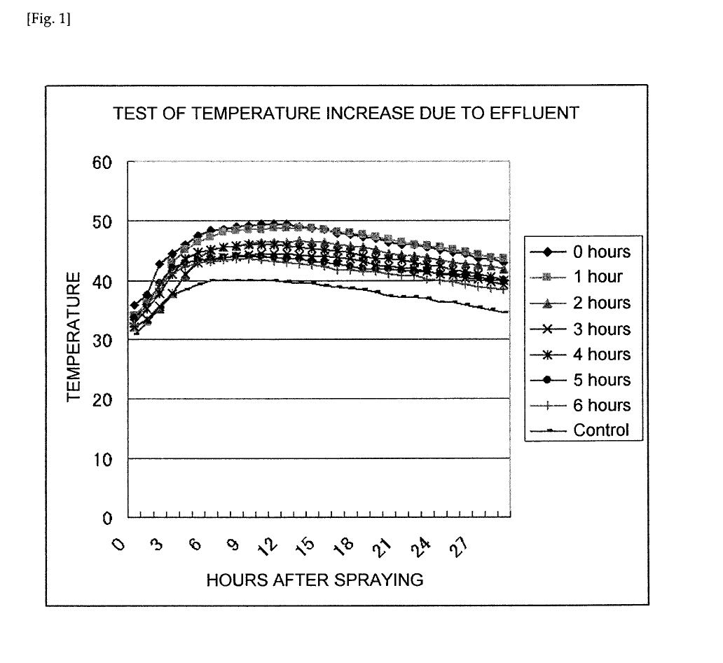

1. A method of treating alcoholic residues by mixing a first koji mold having cellulase activity with an alcoholic fermentation residue, adding the mixture to a koji mold bed containing a second koji mold having amylase activity, and subjecting to a fermentation process.

2. A method in accordance with claim 1, wherein the alcoholic fermentation residue has a water content of at least 60% by mass.

3. A method in accordance with claim 1, wherein said first koji mold is Asp. niger.

4. A method in accordance with claim 1, wherein said first koji mold is added in the form of spores.

5. A method in accordance with claim 4, wherein the spores of koji mold are added at a proportion of at least 10 million per kg of said alcoholic fermentation residue.

6. A method in accordance with claim 1, wherein at least one mold chosen from the group consisting of Asp. oryzae, Asp. awamori and Asp. sojae is further added to the alcoholic fermentation residue.

7. A method in accordance with claim 1, wherein said mixture is added to a koji mold bed containing a second koji mold within 1 hour after mixing the first koji mold into the alcoholic fermentation residue.

8. A method in accordance with claim 1, wherein the mixture is aerated after mixing the first koji mold into the alcoholic fermentation residue until said mixture is added to the koji mold bed containing the second koji mold having amylase activity.

9. A method in accordance with claim 1, wherein said second koji mold is at least one mold chosen from the group consisting of Asp. oryzae, Asp. awamori and Asp. sojae.

10. A method in accordance with claim 9, wherein said second koji mold includes one or both of Asp. oryzae kawachii and Asp. awamori kawachii.

11. A method in accordance with claim 1, wherein the koji mold bed is a koji obtained by growing koji mold on a fibrous substrate containing a starchy material.

12. A method in accordance with claim 1, wherein the weight ratio of the mixture to the koji mold bed is adjusted so that the water content of the koji mold bed after addition of said mixture is within the range of 25-50 wt %.

13. A method in accordance with claim 1, wherein the temperature of the koji mold bed is kept within the range of 25° C. to 50° C. by blowing air into the koji mold bed to which the mixture has been added.

14. A method in accordance with claim 1, wherein the koji mold bed with the mixture added is dried to put the water content of the koji mold-fermented product within the range of 15-35%.

15. A method of treating alcoholic residues by performing the method in accordance with claim 1, then repeating said method using a portion of the resulting koji mold-fermented product as the koji mold bed containing said second koji mold.

16. A feed composition obtained by the method of claim 1.
